(19) United States
(12) Patent Application Publication
(10) Pub. No.: US 2015/0235226 A1
(43) Pub. Date: Aug. 20, 2015

(54) Method of Witnessed Fingerprint Payment

(71) Applicant: Decao Mao, Chino Hills (CN)

(72) Inventor: Decao Mao, Chino Hills (CN)

(21) Appl. No.: 14/417,777

(22) PCT Filed: Jul. 12, 2013
(86) PCT No.: PCT/CN2013/079304

§ 371 Date: Jan. 27, 2015

(30) Foreign Application Priority Data
Aug. 3, 2012 (CN) 201210274262.8

(51) Int. Cl. G06Q 20/40

(52) U.S. Cl. CPC G06Q 20/40145; G06Q 20/4012; G06Q 2220/00

(57) ABSTRACT

A safe method for fingerprint payment, in which no card or password is needed, and the applying of the customer's finger is witnessed by an authorized cashier. For each particular payment, both the customer's fingerprint and the cashier's fingerprint are scanned in real-time, and are sent to the server side together with related payment information; the payment is allowed to accomplish if and only if both fingerprints match their pre-collected counterparts in server side databases. In this process, the cashier plays a role resembling to a public notary or an eye-witness.

### CROSS-REFERENCE TO RELATED APPLICATIONS

This application claims the benefit of Chinese patent application No. 201210274262.8 filed on Aug. 3, 2012 by the present inventor.

### FIELD OF INVENTION

This invention relates to a highly safe method for fingerprint payment, specifically to a method of witnessed fingerprint payment, and devices embodying the method.

### BACKGROUND AND PRIOR ART

Besides cash, so far the most used payment method is pay-by-card, which includes credit cards, bank debt cards, and similar cards issued by various companies and organizations. However, easy as they are in use, it is potentially not safe enough, financial lose caused by stollen, robbed, duplicated credit cards or bank cards heppend from time to time. On the other hand, pay-by-card decides that people have to remember to always carry the cards with them for possible payments, should they forget to carry the cards, or the card is missing or stollen, or simply cannot recall the passwords, they get troubled and embarrassed, and that introduces inconvenience. However, always carrying such cards with you undoubtedly will increase the possibility of getting your card lost or stolen. In this perspective, the ideal method for payment should be pay-by-fingerprint, rather than pay-by-card or pay-by-password. This is because, while fingerprint is unique, is is always with you, it can not not be missing, and you have no need to remember any password either.

As a matter of fact, such technologies already exist, they bind user's pre-collected and saved fingerprint to particular account for payment, whenever you need to pay after shopping or cosume, what you need do is simply put your finger on top of the cashier's on-line payment terminal so that your fingerprint can be scanned and the information will be sent to the payment server. The server, will varify the fingerprint against your pre-collected fingerprint, and will accomplish the payment once it believes the newly scanned fingerprint is authentic. However, while this sounds easy and simple, it is still not safe enough. In fact, to the server side, the credibility of the information coming from the network is not so high, you cannot be sure if the information has been maliciously modified on its route, or it is faked at all, or may be even the terminal is now in the hands of gangsters or criminals.

So, although the technologies for fingerprint collecting and recognition are quite mature, the simple method of using fingerprint for payment is still potentially unsafe.

### OBJECTS AND ADVANTAGES

The object of this invention is to provide a safer method for fingerprint payment, and the specialty of this invention is that at the time of the customer's fingerprint is scanned the cacher's fingerprint is also scanned, and both fingerprints are send to the server side. The server side has the pre-collected fingerprints from both the customer and the cashier in its database, and it will compare both fingerprints against their reserved counterparts respectively. Cashiers are authorized to witness the customer fingerprint scanning, thus playing a role resembling to a public notary. As an option of further strengthening the security, the time, the customer site's geometrical location retrieved from a GPS device, and the ID number of the customer site, can also be send to the server side for verification. In this way, should a criminal try to do some flaudulence, he will have to fake 2 fingerprints simultaneously, and additionally may be will have to provide information in accordance with particular timing and location. Or he would have to provide a faked fingerprint under the monitoring of an authorized cashier, which of course is not easy and very risky. Obviously, such a method of witnessed fingerprint payment will improve the financial safety greatly. Based on that, the invention further provides a design for the customer side terminal device used for this method as well.

To overcome the disadvantages of the existing fingerprint-payment technologies, the present invention provides a safer method of doing fingerprint payment. In this method, customer's fingerprint is used as a proof of the authenticity of the customer's identity, while the cashier's fingerprint is used as a proof of the authenticity of the customer's fingerprint per se. The cashier in this process plays a role similar to a public notary or an eye-witness. Accordingly, the financial safeness of such a witnessed fingerprint-payment is much higher than before.

The process and operational characteristics of said method of witnessed fingerprint-payment provided by this invention, is as following:

(1) Each payment transaction is accomplished by the co-operation of a server and a customer side terminal with at least one fingerprint scanner. Both sides communicate via a network, and the contents of the communication can be ciphered;

(2) The server side has a database for customer fingerprints, these fingerprints are pre-collected when a customer opens an account;

(3) The server side also has a database for fingerprints from authorized cashiers, together with other related information from each cashier, including the cashier's identity, the store or organization the cashier works for, the ID number of the terminal the cashier is authorized to operate, and the location and the time-window the cashier is authorized to operate;

(4) Each customer side terminal has two fingerprint scanners, so that both the customer and the casher can get their fingerprints scanned simultaneously in real time;

(5) Only one fingerprint-scanner on each customer side terminal is also allowed, in that case the 2 fingerprints from the customer and the cashier must be scanned within a predetermined short time period;

(6) Customer side terminal can have builtin GPS and real-time clock devices;

(7) When a payment is made, both fingerprints from the customer and the cashier are scanned on the terminal, and sent to the server side, together with the customer ID number, the ID number of the terminal, the location-info from the builtin GPS device, the timestamp from the real-time clock, and other information related to the particular payment;

(8) On receiving the payment request from customer side, a payment server in the server side using the terminal ID to access the cashier fingerprint database, to find and verify the cashier's fingerprint and the validity of the location and time, then using the customer ID, such as account number or driver licence number, to access the customer fingerprint database to verify the customer's fingerprint. If everything is fine, the server fulfills the payment from the particular account in accordance with the related information from the customer side, and acknowledges to the customer side;

(9) If anything in any step goes wrong during the above said process, the server will notice the customer side, and ask the customer side to re-try or abort, and log the error condition. Alert will be issued and logged, if error conditions happened repeatedly.

### SUMMARY

The advantages of this invention, is that each payment transaction requires both the cashier and the customer scan their fingerprint simultaneously, the cashier plays the role of public notary or an eye-witness. In addition, due to the combination of the terminal ID and the location, and the time window the cashier is authorized to operate the terminal, faking a fingerprint becomes very difficult and highly risky, and thus making the payment much safer.

Furthermore, the method can also be used in cash drowing, since drowing cash from an account is actually a payment transaction in its nature. In this way, for example, even a naked customer can get some cash from a convenient store by applying his fingerprint. Actually, this is equevlent to make a payment to the store from his own bank account or credit account, and then get the money back from the store with some deductions.

### DRAWINGS

FIG. 1 shows the flowchart of the server side process, to be executed by the CPU in one of a group of similar servers.

FIG. 2 shows a customer side terminal device with two fingerprint-scanning modules. Accordingly, FIG. 4 is the flowchart of the customer side process for such a terminal, to be executed by the CPU built-in the device.

FIG. 3 shows a customer side terminal device with only one fingerprint-scanning module. Accordingly, FIG. 5 is the flowchart of the customer side process for such a terminal, to be executed by the CPU built-in the device.

For each step in said processes there are existing technologies and products available, the entire process and system can easily be implemented by ordinary embedded system engineers. Specifically, modules for fingerprint scanning are commercially available, and have been used in systems such as gate entrance control for a while.

### DETAILED DESCRIPTION

Based on above said process and operational characteristics of the method of witnessed fingerprint payment provided by this invention, following is a further description in more detail for its embodiment.

### Server Side Process Embodiment

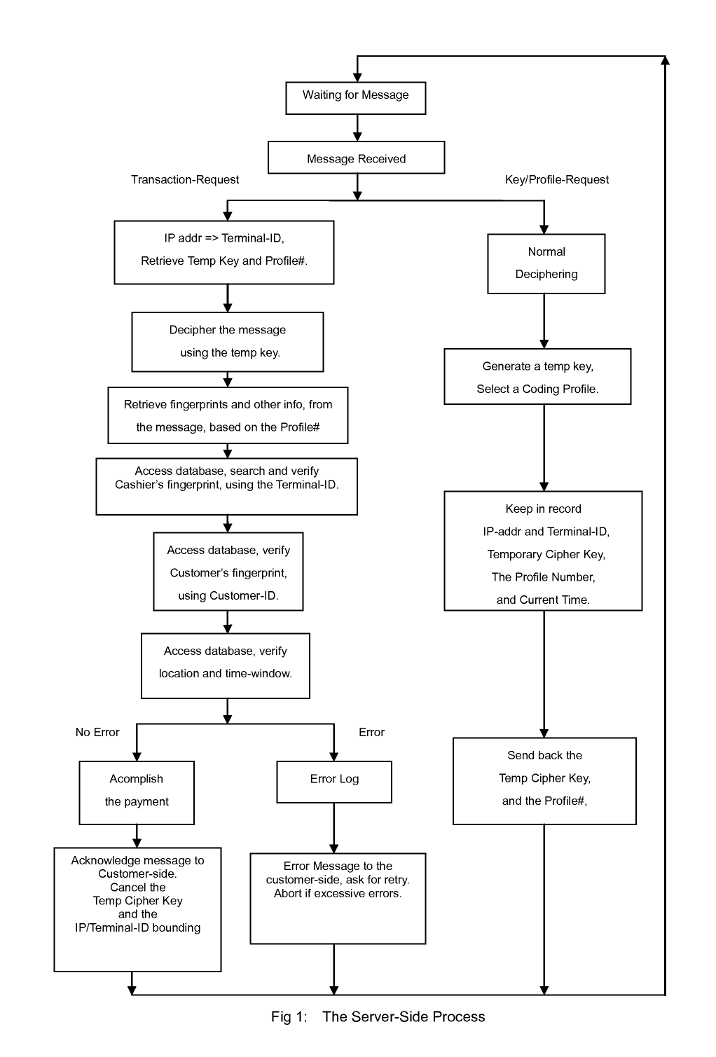

The server side process can be embodied in a server as a software process, FIG. 1 is a flowchart.

Payment request comes from the customer side as IP messages, which are received by the server side process. In this particular embodiment at least 2 messages are needed for each payment transaction, the first one is a request for a temporary cipher key and a coding profile, while the second one is a request for the payment transaction per se. The cipher and coding profile request itself is ciphered as usual; and the message has only one payload field, which is the customer-site ID, namely the terminal ID. On receiving the request, the server-side keeps the current binding of the IP address and the terminal ID in record, then randomly generates a new key for temporary use, and randomly chose a coding profile from a group of pre-determined profiles which is shared by both sides. The temporary key and the profile number are sent back in a reply message, using the normal cipher. After that, both sides use the temporary key for cipher in their communication, untill the payment transaction is done, and thus is canceled by the server side, unless the transaction is timed-out. The payment transaction request is ciphered with the temporary key, it contains the customer ID, the two encoded fingerprints, and other information related to the particular payment. The layout of the message is decided by the chosen coding profile, rather than following a fixed layout. In this way, even if the messages are intercepted and hacked, it is still difficult for the hackers to figure out the layout of the contents.

On receiving the payment transaction request, the server process uses the customer-site ID to access the cashier fingerprint database, searching and comparing against the received cashier's fingerprint for a match. In any particular store the number of authorized cashier is always limited, and thus the searching and comparing should be quick enough. Once the cashier's fingerprint is verified, the Customer ID is used to access the customer fingerprint database, and the received customer's fingerprint is verified. Customer ID and customer's fingerprints are bonded together, and therefore the verification is also quick. Passed the two verifications, the customer-site location and the timestamp from the request message are checked with pre-specified rules in the database, regarding the particular cashier. If everything is correct, the transaction is fulfilled in accordance with the payment information in the request message, and acknowledge is sent back to the customer side, and the temporary cipher key for the transaction is canceled. Otherwise, the server-side will log the error condition, ask the customer-side to remove the error, re-scan the fingerprints, and send a new request. Alert will be issued and logged if error conditions happened repeatedly.

### Customer-Side Process Embodiment 1

### Fingerprint Terminal with 2 Scanning Windows

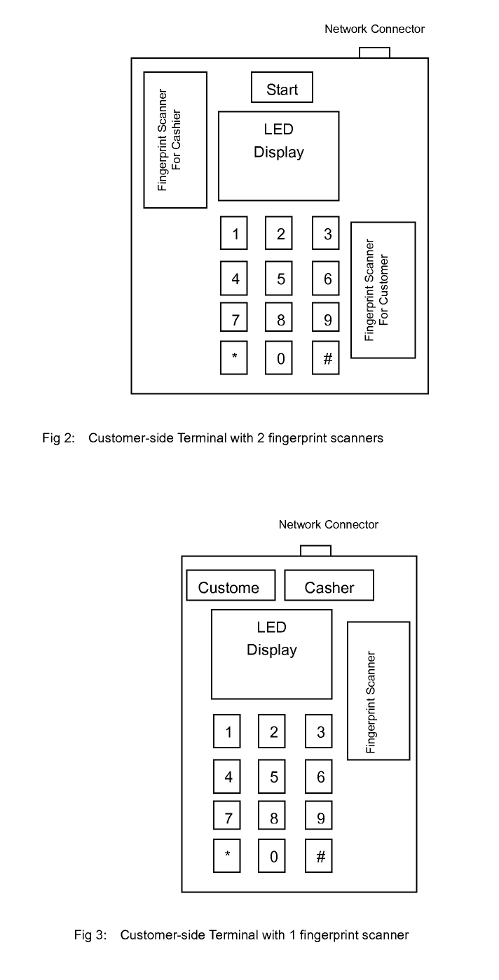

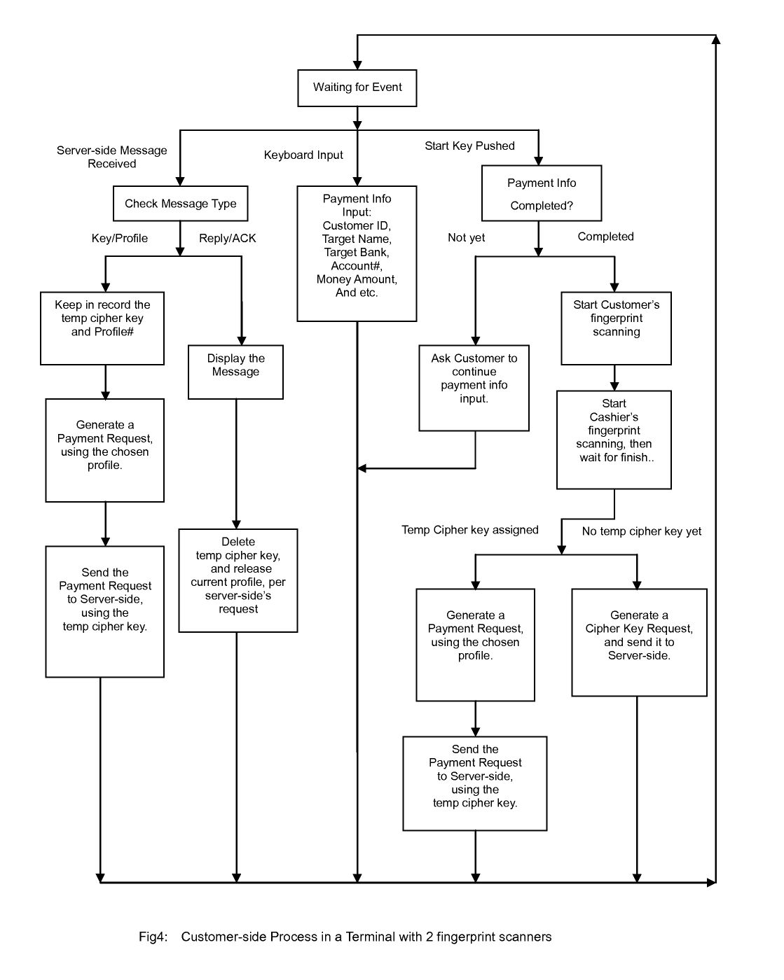

FIG. 2 shows a customer side terminal with two fingerprint scanning modules, which is the preferred customer side process embodiment of this invention. The terminal device has a display screen, and a keyboard similar to these used on cellular phones. The keyboard is used to input customer ID, payment information like dollar amount and account number of the target account, and so forth. Specifically, the device has two fingerprint scanning windows in opposite directions, one for customer and one for cashier. Related is a button for “Start”, once the payment info is entered, both the customer and the cashier put their fingers on the scanning windows, and push the Start button. The terminal starts to scan both fingerprints, generates and sends requests to the server side following the flowchart in FIG. 4, and wait for response. If the reply from the server side is a success, then the payment is done. Otherwise an error message will be displayed on the screen, and the customer side may re-do the process, or just give up.

The hardware structure of the customer side terminal consists of a CPU and memory, network interface, power, LED screen, fingerprint scanning windows, GPS module, real-time clock, and so forth, it is an embedded system similar to a cellular phone. Network interface can be wired or wireless, difference in such details will not change the scope and substance of this invention.

### Customer-Side Process Embodiment 2

### Fingerprint Terminal with 1 Scanning Window

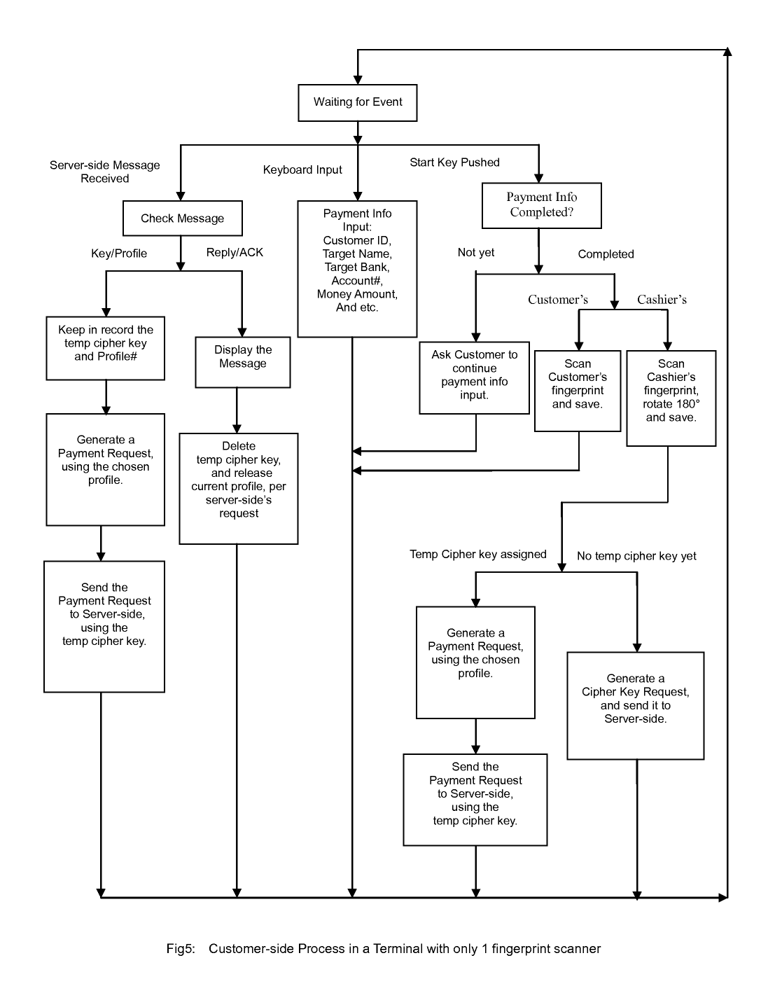

FIG. 3 illustrates a customer side terminal with only 1 scanning module. The device has only one fingerprint scanning window, but it has two Start buttons, one for customer and one for cashier. The two fingerprints have to be scanned within a pre-determined time interval before time-out. The first fingerprint is cached inside the device, and will be sent together with the second fingerprint simultaneously. Usually the cashier and the customer stand in opposite directions, and therefore the device will rotate the cashier's fingerprint image for 180 degrees after scanning Otherwise there is no defference between this embodiment and the preferred embodiment. FIG. 5 is a flowchart for this process.

### CONCLUSION, RAMIFICATIONS, AND SCOPE

The above said embodiments are substantial to this invention, but ramifications do exist. For example, the method provided in this invention can be embodied into larger POS devices, so that in addition to fingerprint the POS can also scan bar-codes and even RFIDs. Another example is that an interface can be added, so that the device can be connected to a PC, and then the payment information can be edited or generated on the PC. Furthermore, communications between the terminal devices and the server can be enciphered. However, such details and ramifications will not change the substance and the scope of this invention, which is: providing the customer's fingerprint and the cashier's fingerprint simultaneously, make the cashier playing a role resembling to a public notary or an eye-witness. In addition, some technical details pertaining to common senses are not menssioned in the descriptions and the figures for simplification, to embedded-system engineers these are just basic skills, and thus will not impair the substance of this invention either.

Thus the scope of the invention should be determined by the appended claims and their legal equivalents, rather than by the examples given.

Note that the core of this invention is the exercise of witnessed fingerprint; “witnessed fingerprint payment” is actually “payment based on witnessed fingerprint”. However, the method not only can be used for payment, but also for other activities as well, such as witnessed fingerprint signature, witnessed fingerprint confirmation, witnessed fingerprint authentication, and so forth. Essentially, whenever a signature is needed for whatever, a witnessed fingerprint is a proper substitute.

1. A safe method for fingerprint payment, comprising:
1.1) accomplishing each payment based on fingerprints and customer's ID number;
1.2) each payment is accomplished by the co-operation of a payment processing server in server side and a terminal with fingerprint scanner in customer side, communicating via a network;
1.3) for each particular payment, both the customer's fingerprint and the cashier's fingerprint are scanned on the customer side terminal in real-time, and are sent to the server side together with the terminal ID, customer ID, and other related information;
1.4) the server side maintains pre-collected fingerprints from customers and authorized cashiers in its databases;
1.5) the server side accesses its database using the customer side terminal ID, searching and verifying the cashier's fingerprint for match, then accesses its database using the customer ID, verifying the customer's fingerprint for match;
1.6) the payment is allowed to accomplish if and only if both fingerprints from the customer side matching their pre-collected counterparts in databases.

2. The method of claim 1 wherein:
2.1) said customer side fingerprint scanning terminal contains a GPS locating device;
2.2) said customer side fingerprint scanning terminal appends the location info collected from the GPS device and a timestamp into the payment request message sent to the server side.

3. The method of claim 1 and claim 2 wherein:
3.1) said terminal contains 2 fingerprint scanners, scanning both customer's and cashier's fingerprints simultaneously when a payment request is to be made.

4. The method of claim 1 and claim 2 wherein:
4.1) said terminal contains only 1 fingerprint scanner, customer's fingerprint and cashier's fingerprints are scanned in turn within a predetermined time interval when a payment request is to be made.
